(19) United States
(12) Patent Application Publication
(10) Pub. No.: US 2013/0025709 A1
(43) Pub. Date: Jan. 31, 2013

(54) AUTOMATED PIPE FREEZE PROTECTION SYSTEM

(71) Applicants: JASON BRIAN MANN, Baton Rouge, LA (US); Fred Stephen Lehman, Baton Rouge, LA (US)

(72) Inventors: JASON BRIAN MANN, Baton Rouge, LA (US); Fred Stephen Lehman, Baton Rouge, LA (US)

(21) Appl. No.: 13/190,852

(22) Filed: Jul. 26, 2011

(51) Int. Cl. F16K 17/36

(52) U.S. Cl. 137/468

(57) ABSTRACT

An automated pipe freeze protection system is disclosed. The system includes tubing, a detector module, and a valve configured to open and circulate unfrozen water through plumbing in the event ambient temperature is detected to be near a freezing point.

### BACKGROUND OF THE INVENTION

The present invention generally relates to plumbing, and more particularly, to an automated pipe freeze protection system.

In certain climates, hard freezes are very common, and the plumbing may not be designed to handle freezing temperatures. Some solutions include either insulating an exterior water spigot or heating the water lines. Insulating the exterior water spigot may only insulate a small section of pipe. The water pipe can freeze in a poorly insulated area of the home, for example. Wrapping the water line with heat tracing to heat the water lines to stop the water from freezing may not be energy efficient, and there can exist a potential fire hazard. Alternatively, a valve may be attached to the exterior water spigot. The drip of water from the spigot can freeze because it is exposed to the outside temperature. Dripping water on the ground can also cause a hazard.

Some other methods may include circulating water using moving parts. In order to circulate the water, a plumber may cut into an existing plumbing line to install some of the parts.

As can be seen, there is a need for a system of circulating water by anticipating freezing temperatures while avoiding exposure of the water source to a frozen environment.

### SUMMARY OF THE INVENTION

In one aspect of the present invention, a system adaptable for fitting to a plumbing water source comprises tubing coupled to the water source; a valve coupled to the tubing configured to circulate unfrozen water out from the water source through the tubing; and a detector module connected to the valve, the detector adapted to sense temperature and configured to send a command signal to the valve to open, wherein the command signal is based on a sensed temperature and a predetermined temperature threshold.

In another aspect of the present invention, a system of preventing frozen plumbing comprises a temperature sensor, the temperature sensor configured to detect a first threshold temperature and a second threshold temperature; a wireless transmitter coupled to the temperature sensor; first and second hoses adaptable for tapping into respective hot and cold water sources, wherein the first and second hoses are joined into a common hose; a valve coupled to the common hose; and a wireless receiver attached to the valve, wherein the wireless receiver is configured to receive a wireless signal from the wireless transmitter, the wireless signal is based on detection of the first or second threshold temperatures by the temperature sensor, and the valve is adapted to open or close based on the wireless signal.

These and other features, aspects and advantages of the present invention will become better understood with reference to the following drawings, description and claims.

### BRIEF DESCRIPTION OF THE DRAWINGS

FIG. 1 is a perspective view of an automated pipe freeze protection system according to an exemplary embodiment of the present invention;

FIG. 2 is an exploded perspective view of an exemplary temperature controlled detector/transmitter used in the system of FIG. 1;

FIG. 3 is an exploded perspective view of an exemplary junction assembly used in the system of FIG. 1;

FIG. 4 is an exploded perspective view of an exemplary solenoid/bracket assembly used in the system of FIG. 1;

FIG. 5 is an exploded perspective of an exemplary water faucet and tube assembly used in the system of FIG. 1; and

FIG. 6 is a flow diagram of illustrating a series of steps according to an exemplary method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a system for prevention of frozen pipes. In one aspect, the system may tap into a typically warm or unfrozen water source that is protected from freezing conditions and may circulate unfrozen water into plumbing that is or may be in danger of freezing. In another aspect, the system may include a sensor and an automated valve that may be configured to detect when temperatures are approaching freezing points and may activate/deactivate supply of the unfrozen water source to other plumbing.

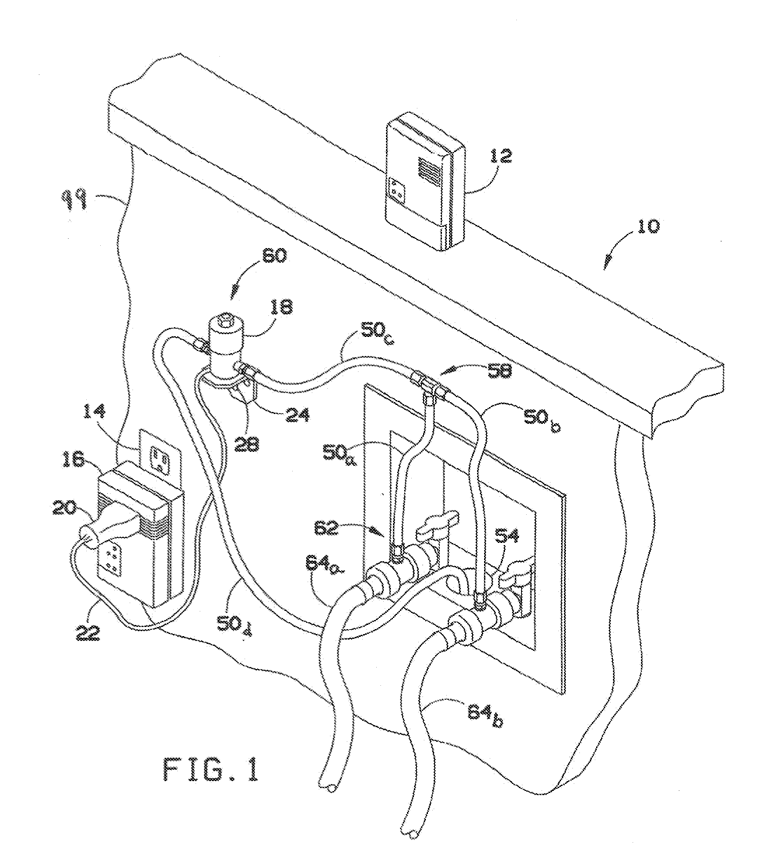

Referring now to FIG. 1, an automated freeze pipe protection system 10, (also generally referred to as the system 10) includes tubing 50, a valve 18, and a detector module 12. In one exemplary environment, the system 10 may be connected to a laundry room wall 99 that includes an electric socket 14 and a hot and cold water source 64a and 64b.

The flow of water may be tapped into and drawn from water sources 64a and 64b in anticipation of freezing conditions. Water may be circulated through the system 10 into other plumbing sections (not shown) of a building (not shown) through tubing 50 depending on the open or closed status of the valve 18. The tubing 50 may include multiple portions, for example, hot water hose 50a, cold water hose 50b, common hose 50c, and drain hose 50d. The hot water hose 50a and cold water hose 50b may be connected to hot and cold water sources 64a and 64b respectively at a water hose and faucet connection assembly 62. While the following disclosure will be described primarily in the context of using both hot and cold water sources, it will be understood that the system 10 may also be employed using a single water source in some embodiments. The hoses 50a and 50b may be joined together to connect to and draw water into the common hose 50c at a junction 58.

The common hose 50 may be coupled to an entry side of the valve 18 and configured to feed water there through depending on the open or closed status of the valve. When closed, water may not be circulating through the system 10. When the valve 18 is open, water may circulate through the valve 18 into a drain hose 50d connected on an exit side of the valve 18 feeding water into a drain 54.

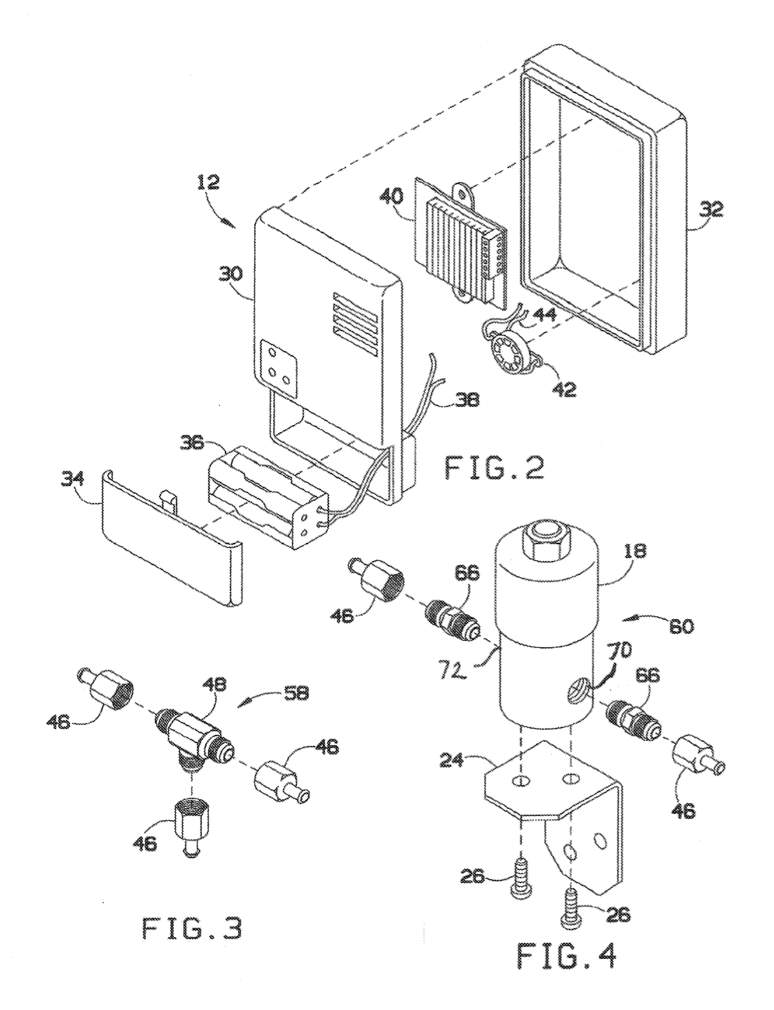

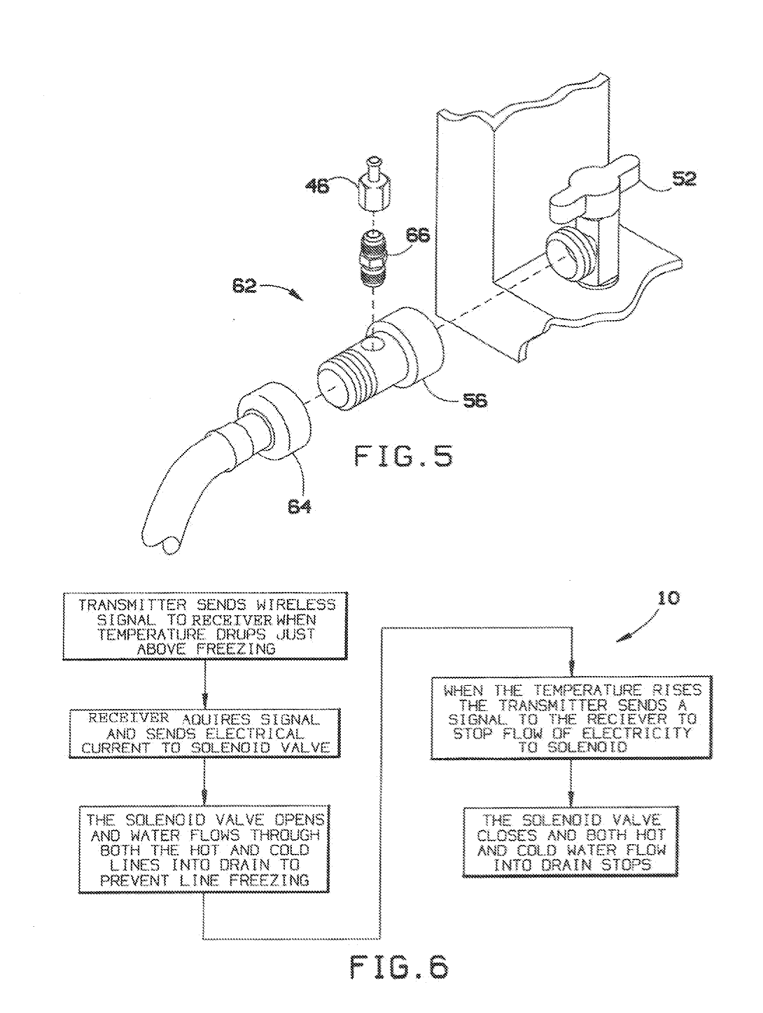

Referring now to FIGS. 1, 2, and 6, the open or closed status of the valve 18 may be determined by the detector module 12. The detector module 12 may be configured to sense temperature. The detector module 12 may include a front housing cover 30, a back housing cover 32, a battery cover 34, a battery pack 36, a circuit board 40, and a temperature sensor 42. The temperature sensor 42 may be connected to the circuit board 40 via wires 44. Power may be supplied to the circuit board 40 and sensor 42 by the battery pack 36 through wires 38.

The sensor 42 may be configured to supply temperature level signals to the circuit board 40. The circuit board 40 may be configured to process the temperature level signals and determine whether the ambient temperature is above or below one or more threshold temperatures. For example, the circuit board 40 may be configured to determine if the ambient temperature is near a freezing point, for example, at 35° F. or below, and may supply a signal to open the valve 18. The circuit board 40 may also be configured to determine if the ambient temperature is 45° F. or higher, for example, and may supply a signal to the receiver 16 to close the valve 18 or maintain it closed in the event the valve 18 has been closed.

In one aspect the detector module 12 may be configured for wireless transmission of open/closed signals. For example, the detector module 12 may include a separate receiver unit 16 plugged into the wall socket 14. The receiver 16 may be connected to the valve 18. The receiver 16 may be configured to receive “open” or “close” command signals from the circuit board 40 thus providing an activation or deactivation of the valve 18. While the detector module 12 is shown primarily in the context of being disposed within a room with the wall 99, in another aspect, the detector module 12 may be disposed with the temperature sensor 42 disposed outside of the room with the wall 99, for example, outside of a building entirely.

Referring now to FIGS. 1 and 3, the junction 58 may be, for example, a brass tee. The junction 58 may include three fittings 46 adapted for coupling to respective hoses (not shown) and coupled to a tee fitting.

Referring now to FIGS. 1 and 4, a valve assembly 60 may include the valve 18 mounted the wall 99 by a bracket assembly 24 via screws 28. The valve 18 may be, for example, a solenoid valve. Straight brass fittings 66, for example, may be coupled to entry port 70 and exit port 72 of the valve 18 and to respective fittings 46 of hoses 50c and 50d.

Referring now to FIG. 5, an exemplary connection of a faucet connection assembly 62 to a faucet 52 is shown. A threaded washer connection 56 may couple a washer hose 64 to the faucet 52. Threaded fitting 66 may couple the washer connection 56 to a fitting 46.

It should be understood, of course, that the foregoing relates to exemplary embodiments of the invention and that modifications may be made without departing from the spirit and scope of the invention as set forth in the following claims.

What is claimed is:

1. A system adaptable for fitting to a plumbing water source, comprising:
tubing coupled to the water source;
a valve coupled to the tubing configured to circulate unfrozen water out from the water source through the tubing; and
a detector module connected to the valve, the detector adapted to sense temperature and configured to send a command signal to the valve to open, wherein the command signal is based on a sensed temperature and a predetermined temperature threshold.

2. The system of claim 1, wherein the detector module includes a wireless transmitter and receiver.

3. The system of claim 1, further comprising a circuit board configured to determine whether the sensed temperature is at or below the predetermined temperature threshold.

4. The system of claim 3, wherein the command signal to the valve opens the valve is based on the sensed temperature being at or below the threshold temperature.

5. A system of preventing frozen plumbing, comprising:
a temperature sensor, the temperature sensor configured to detect a first threshold temperature and a second threshold temperature;
a wireless transmitter coupled to the temperature sensor;
first and second hoses adaptable for tapping into respective hot and cold water sources, wherein the first and second hoses are joined into a common hose;
a valve coupled to the common hose; and
a wireless receiver attached to the valve, wherein
the wireless receiver is configured to receive a wireless signal from the wireless transmitter,
the wireless signal is based on detection of the first or second threshold temperatures by the temperature sensor, and
the valve is adapted to open or close based on the wireless signal.

6. The system of claim 5 wherein the valve is a solenoid valve.

7. The system of claim 5 wherein the valve is configured to open and circulate water based on the first threshold temperature being near a freezing point temperature.
